(19) United States
(12) Patent Application Publication
(10) Pub. No.: US 2013/0258810 A1
(43) Pub. Date: Oct. 3, 2013

(54) Method and System for Tomographic Inversion

(71) Applicant: Wenyi Hu, Katy, TX (US)

(72) Inventor: Wenyi Hu, Katy, TX (US)

(21) Appl. No.: 13/748,134

(22) Filed: Jan. 23, 2013

Related U.S. Application Data
(60) Provisional application No. 61/618,224, filed on Mar. 30, 2012.

(51) Int. Cl. G01V 1/30

(52) U.S. Cl. CPC G01V 1/303
USPC 367/73

(57) ABSTRACT

Method and system is described for reducing sensitivity imbalance issues and/or implements target-oriented tomography to enhance tomographic inversion for velocity model building. The method may include performing a preparation stage to construct a measurement vector from seismic data and a kernel matrix from ray-path information; performing a sensitivity optimization stage to generate a data weighting vector; and performing a property optimization stage to reconstruct a subsurface model of one or more geophysical properties.

### CROSS-REFERENCE TO RELATED APPLICATION

This application claims the benefit of U.S. Provisional Patent Application 61/618,224, filed Mar. 30, 2012, entitled METHOD AND SYSTEM FOR TOMOGRAPHIC INVERSION, the entirety of which is incorporated by reference herein.

### FIELD OF THE INVENTION

This invention relates generally to the field of seismic prospecting and more particularly to seismic data processing. Specifically, the invention is a method for reducing sensitivity imbalance issues and/or implement target-oriented tomography to enhance tomographic inversion for velocity model building, seismic attenuation model building, and other geophysical property model building.

### BACKGROUND OF THE INVENTION

In the oil and gas industry, a technique called ray-based tomographic inversion is used to build models in the form of data volumes giving seismic wave velocity values or seismic attenuation property values (Q) within a subsurface volume of interest, which include natural resources, such as hydrocarbons. These techniques may be utilized to enhance geophysical exploration and production.

Ray-based tomographic inversion is one of various methods for estimating the geophysical properties of a subsurface volume (e.g., information in the model domain) by analyzing the seismic traces recorded by the receivers (e.g., information in the data domain) provided that these seismic traces travel from the source, then penetrate the subsurface volume represented by a subsurface model in model domain, and eventually arrive at the receivers because these seismic traces carry some information of the geophysical properties of the subsurface model.

Conventional ray-based tomographic inversion techniques involve algorithms that have certain limitations, which prevent the algorithms from reconstructing reliable and accurate subsurface models of geophysical properties. That is, as a result of the non-uniqueness and the ill-conditioned nature of the geophysical tomographic inversion problems, the quality and the reliability of the tomographic inversion results are highly dependent on the sensitivity distribution pattern of the inversion kernel matrix. The sensitivity distribution of the kernel matrix is essentially determined by the seismic ray density for this type of technique.

Unfortunately, in most seismic surveys, the seismic data coverage is non-uniform and as a result the sensitivity distribution of the tomographic inversion kernel matrix may be seriously unbalanced. The non-uniform seismic ray coverage may result from non-uniform shot and receiver distribution, varying azimuth angle range for different shots, and/or varying offset range for different shots. Further, even if the seismic data coverage (e.g., shot/receiver spacing within regions) is relatively uniform, the subsurface ray density distribution can vary substantially with location and depth. For example, in a walkaway check-shot seismic survey, the seismic ray density decreases with the distance from the wells even if the shot distribution is uniform on the surface. Another cause of non-uniform seismic ray density is the seismic velocity model. That is, seismic rays converge in some regions, while diverge in other regions due to the seismic velocity spatial variation. Therefore, for a given seismic survey shot/receiver geometry and a given seismic velocity model, the seismic ray density is fixed. The conventional tomographic inversion algorithms tend to focus on the regions associated with high inversion sensitivity because the geophysical property updates in these regions has more impact on the data misfit minimization. Therefore, the reconstructed geophysical properties (e.g., seismic velocity, seismic attenuation property Q, etc.) in the subsurface model may be inaccurate.

In addition to the sensitivity imbalance problems, many geophysical tomography applications are directed to specific or localized regions and attempt to update the geophysical properties in these localized regions relating to a portion of the subsurface volume. This area of geophysical applications can be referred to as the target-oriented tomography. Conventional tomographic inversion algorithms are unable to solve the tomographic inversion problems in a target-oriented sense because the targeted regions are not necessarily associated with high inversion sensitivity. In other words, as long as the seismic survey geometry and the seismic velocity model are fixed, the ray density distribution is fixed and the regions associated with high inversion sensitivity are also fixed although these regions may not be the target of interest.

To overcome these difficulties in geophysical property model building, various techniques are provided. One approach to handle the sensitivity imbalance is the regularization technique. While the regularization technique can produce stable inversion results by smoothing the subsurface models to be reconstructed, this method reduces accuracy for highly non-uniform seismic ray coverage and may even introduce artifacts into the subsurface model. As a particular example, Wang et al. describe that in handling non-uniform seismic data coverage using variable grid spacing, the grid spacing varies to include more or fewer rays (larger grid spacing in areas with poor ray coverage and smaller grid spacing in areas with good ray coverage) to balance the tomographic sensitivity distribution. See Wang, B. and L. W. Braile, Effective approaches to handling non-uniform data coverage problem for wide-aperture refraction/reflection profiling, SEG Expanded Abstracts vol. 14, p. 659-662 (1995), http://dx.doi.org/10.1190/1.1887398. However, the implementation of this approach can be complicated and the resolution of the reconstructed model is non-uniform. As another example, Wang et al. describes that variable damping may be utilized to handle non-uniform seismic data coverage. The variable damping utilizes a large damping factor in areas associated with poor seismic ray coverage, while small damping factor is used in areas with high ray density. Again, this approach leads to non-uniform resolution in the inversion domain (e.g., model domain) and may have stability problems.

Another technique to address tomography sensitivity imbalance issues is the preconditioning technique. The preconditioning technique utilizes the sensitivity information to steer the search direction away from the gradient-based direction to direct it toward a better solution. Examples of this technique are described Wang and Rao, Dines et al. and Stork et al. See Wang, Y. and Y. Rao, Reflection seismic waveform tomography, Journal of Geophysical Research, vol. 114, B03304 doi:10.1029/2008JB005916 (2009); Dines, K. A., and Lytle, R. J., Computerized geophysical tomography: Proc. IEEE, vol. 67, p. 1065-1073, doi: 10.1109/PROC.1979.11390 (1979); and Stork, C. and Clayton, R. W., Linear aspects of tomographic velocity analysis, Geophysics, vol. 56, p. 483-495, doi:10.1190/1.1443065 (1991). Wang and Rao describe a scaling factor designed as a depth-dependent function to approximate the main diagonal entries of the inverse Hessian matrix to be used as a preconditioner for reflection seismic waveform tomography. In closely related work reported by Dines et al. and by Stork et al., a stabilized model weighting scheme was used to scale the back-projection results. However, the tomography results are overly sensitive to the value of the stabilizing factor, which is unclear from the references how to determine this value. In fact, when the stabilizing factor is small, this approach, which tends to place extremely large weight on those grids with extremely short ray-paths, has stability and uncertainty issues.

In yet another technique, Zhou describes a multi-scale tomography method. See Zhou, H., Multiscale traveltime tomography, Geophysics, vol. 68, p. 1639-1649, doi:10.1190/1.1620638 (2003). In multi-scale tomography method, the inversion domain is decomposed into sub-models of different cell sizes. These different scale inversion problems are solved simultaneously and the solutions are summed up as the final solution to the original tomography problem. While this approach overcomes the ill-conditionedness and mitigates the non-uniqueness to some extent, this multi-scale tomography method is implicitly a regularization technique, which results in the reconstructed geophysical property models having low resolution, as noted in Zhou. While this approach was intended to deal with the issue that single-scale tomography from traveltimes may result in under-determinacy in regions with insufficient ray density, the inversion sensitivity in the regions with poor ray coverage are boosted by sacrificing the resolution. For example, if there is only one cell in the whole inversion domain, then the poor ray coverage problem is avoided, but the resolution is lost completely.

Data weighting methods are yet another technique that may be utilized, which is described in Berryman and Abubakar et al. See Berryman, J. G., 1989, Weighted least-squares criteria for seismic traveltime tomography, IEEE Transactions on Geoscience and Remote Sensing, vol. 27, no. 3, p. 302-309 (1989); and Abubakar, A., T. M. Habashy, M. Li, and J. Liu, Inversion algorithms for large-scale geophysical electromagnetic measurements, Inverse Problems, vol. 25 123012 doi:10.1088/0266-5611/25/12/123,012 (2009). Abubakar et al. describes a general data weighting scheme, which is referred to as Jacobian data weighting. The reference describes that it was applied in the nonlinear controlled-source electromagnetic inversion, where it reduces the contribution of the short-offset data in the inversion process and suppresses the near surface effects. In Berryman's method, weights are applied on both the measurement data and the models to be inverted. The data weighting scheme, which is based on powers of the ray-path length, was derived with the assumptions that: i) signal-to-noise ratio is better on shorter ray-paths than on longer ray-paths; and ii) shorter ray-paths are more reliable than longer ray-paths. Both of these data weighting methods tend to balance the data misfit amount contributed from different measurements in the data domain without quantitatively balancing the inversion sensitivity in the model domain. This approach does not have quantitative control on the sensitivity distribution within the model.

Each of the techniques described above are incapable of target-oriented tomographic inversion. However, Tang et al. describes a target-oriented wavefield tomography method to locally reconstruct a seismic velocity model. See Tang, Y. and B. Biondi, Target-oriented wavefield tomography using demigrated Born data, SEG Expanded Abstracts vol. 29, 4280, http://dx.doi.org/10.1190/1.3513764 (2010). The method uses demigrated data (i.e., approximated data obtained through Born approximation and starting velocity model) for inversion. As a result, this method inevitably introduces addition errors due to demigrated data. In addition, the method tends to generate artificial discontinuities during merging the target region into the global model domain. Further, this method is unable to balance or quantitatively control the inversion sensitivity (even in the target region) because the data selection approach is based on back-propagation instead of inversion (i.e., matrix transpose instead of matrix inverse).

As the recovery of natural resources, such as hydrocarbons, rely, in part, on subsurface model, a need exists to enhance tomographic inversion for velocity model building, seismic attenuation (Q) model building, and other geophysical property model building. In particular, a need exists to reduce sensitivity imbalance issues and/or implement target-oriented tomography.

### SUMMARY OF THE INVENTION

In one embodiment, a computer-implemented method for constructing a subsurface model of a subsurface volume from survey data (e.g., seismic data, or other suitable) for a geophysical property is described. The method comprises: (a) constructing a measurement vector from seismic data; (b) constructing a kernel matrix from ray-path information; (c) constructing a sensitivity optimization cost function based on the kernel matrix; (d) deriving data weighting vector by minimizing the sensitivity optimization cost function; (e) constructing a sensitivity-controllable tomographic inversion cost function by applying the data weighting vector; (f) obtaining a starting subsurface model; and (g) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function. The step (c) of the method may comprise transposing the kernel matrix to build an adjoint sensitivity mapping matrix that is utilized to construct the sensitivity optimization cost function. The step (c) may include using a sensitivity distribution along with the kernel matrix, wherein the sensitivity distribution may be uniform or specifically targeted for a region of interest.

In yet another embodiment, a computer-implemented method for constructing a subsurface model of a subsurface volume from survey data, such as seismic data, for a geophysical property is described. The method comprises: (a) constructing a measurement vector from seismic data; (b) constructing a kernel matrix from ray-path information; (c) constructing a sensitivity optimization cost function based from the kernel matrix and on a sensitivity distribution; (d) deriving data weighting vector by minimizing the sensitivity optimization cost function; (e) constructing a sensitivity-controllable tomographic inversion cost function by applying the data weighting vector; (f) obtaining a starting subsurface model; and (g) generating a subsurface model of the geophysical property by solving the sensitivity-controllable tomographic inversion problem with the starting subsurface model, wherein the sensitivity-controllable tomographic inversion problem is based on the sensitivity-controllable tomographic inversion cost function. The step (c) may also comprise obtaining a targeted sensitivity distribution and using the targeted sensitivity distribution with the kernel matrix to construct the sensitivity optimization cost function.

In yet still another embodiment, a method for producing hydrocarbons from a subsurface region is described. The method comprises: (a) obtaining seismic data from a survey of the subsurface volume; (b) obtaining a subsurface model for the subsurface volume of a one or more geophysical properties, the subsurface model being generated by: (i) constructing a measurement vector from seismic data; (ii) constructing a kernel matrix from ray-path information; (iii) constructing a sensitivity optimization cost function based on the kernel matrix; (iv) deriving data weighting vector by minimizing the sensitivity optimization cost function; (v) constructing a sensitivity-controllable tomographic inversion cost function by applying the data weighting vector; (vi) obtaining a starting subsurface model; and (vii) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function; (c) imaging the seismic data using the subsurface model; (d) drilling at least one well to the subsurface volume in a formation based on the seismic image; and (e) producing hydrocarbons from the formation.

In still yet another embodiment, a computer system is described. The computer system comprises a processor; memory in communication with the processor; and a set of instructions stored on the memory and accessible by the processor. The set of instructions, when executed, are configured to: obtain a measurement vector and a kernel matrix; construct a sensitivity optimization cost function based on the kernel matrix; calculate a data weighting vector by minimizing the sensitivity optimization cost function; construct a sensitivity-controllable tomographic inversion cost function by applying the data weighting vector; obtain a starting subsurface model; and produce a subsurface model of a geophysical property solving a sensitivity-controllable tomographic inversion problem with the starting subsurface model, wherein the sensitivity-controllable tomographic inversion problem is based on the sensitivity-controllable tomographic inversion cost function. Further, the set of instructions is configured to obtain a targeted sensitivity distribution and to construct the sensitivity optimization cost function from the targeted sensitivity distribution with the kernel matrix.

### BRIEF DESCRIPTION OF THE DRAWINGS

The foregoing and other advantages of the present disclosure may become apparent upon reviewing the following detailed description and drawings of non-limiting examples of embodiments. Due to patent law restrictions on the use of color, FIGS. 3-12 are black and white reproductions of color drawings.

FIG. 1 is a flow chart for implementing sensitivity-controllable tomography in accordance with an exemplary embodiment of the present techniques.

FIG. 2 is another flow chart for implementing sensitivity-controllable target-oriented tomography in accordance with an exemplary embodiment of the present techniques.

FIGS. 3 to 12 illustrate exemplary graphs associated with synthetic data examples as applied to conventional techniques and certain aspects of the present techniques.

### DETAILED DESCRIPTION OF THE PREFERRED EMBODIMENTS

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The present disclosure describes an inversion-based data weighting method having quantitative sensitivity control. With this technique, a very well-balanced sensitivity distribution may be achieved for global tomographic inversion applications and an arbitrary user-specified sensitivity distribution can be obtained for target-oriented tomographic inversion applications. In the sensitivity-balanced tomographic inversion, this method provides a data weighting scheme, which provides a nearly uniform inversion sensitivity distribution. Applying this data weighting scheme on both the kernel matrix and the measurement data, one is able to circumvent the sensitivity imbalance issue present in other techniques.

Further, while certain conventional techniques are incapable of target-oriented tomographic inversion or fail to provide adequate results, the present techniques may also provide a method to enhance target-oriented tomography through sensitivity control. For target-oriented tomographic inversion, uniformly distributed inversion sensitivity may not be preferred. Accordingly, a method to obtain an arbitrary sensitivity distribution specified by users to implement the tomographic inversion in a target-oriented sense may be preferred. Therefore, from a mathematical point of view, the sensitivity-balanced tomography discussed here is just a special case of the sensitivity-controllable target-oriented tomography where the targeted sensitivity distribution is a uniform profile.

One or more embodiments of the present techniques include a method for a quantitative control of two-dimensional (2D) or three-dimensional (3D) ray-based tomographic inversion sensitivity through a data weighting scheme, which is derived numerically by solving a sensitivity optimization problem. This sensitivity optimization problem is based on the mapping of the to-be-determined data weights from the data domain to the model domain through the adjoint operator (A^{T}, which is represented as equation (e10) below) of the original kernel matrix (e.g., the initially constructed kernel matrix from the ray-path information (e.g., A which is represented in equation (e3) below). This method may be utilized to enhance: i) sensitivity-balanced tomographic inversion; and/or ii) sensitivity controllable target-oriented tomographic inversion.

The method may include certain features to enhance the tomographic inversion. The process flow may include initial data and model preparation stage followed by a sensitivity optimization stage and a property optimization stage. The initial data and model preparation stage may include constructing a kernel matrix (e.g., A in equation (e3) below) and measurement vector (e.g., b in equation (e3) below). The sensitivity optimization stage may include determining or designing a targeted sensitivity distribution, constructing a sensitivity optimization cost function and solving the sensitivity optimization problem to obtain a data weighing scheme. The property optimization stage may include applying the data weighting scheme, obtaining the sensitivity-controllable cost function and solving the property optimization problem to reconstruct properties.

As an example, the method may include various steps. One step may include constructing a kernel matrix and then a targeted sensitivity distribution may be determined (for sensitivity-balanced tomography, the targeted sensitivity distribution may be uniform; while for target-oriented tomography, the targeted sensitivity distribution is designed and specified by the users). With the targeted sensitivity distribution, a sensitivity optimization cost function may be constructed and the sensitivity optimization problem may be solved iteratively to obtain a data weighting scheme, which quantitatively controls the inversion sensitivity distribution as designed. This data weighting scheme may be nearly optimal (e.g., the preferred sensitivity distribution is obtained, which may be within a specific range or threshold). Then, the data weighting scheme is applied to the original tomographic inversion cost function (which is indicated as equation (e4)) to convert it to a new optimization problem whose sensitivity is different from the original (which is indicated as equation (e7)), which are discussed further below. Eventually, this new optimization problem (e7) can be solved without introducing any significant artificial discontinuity and extra nonlinearity in the inversion process. These aspects may be further clarified in relation to the below discussion for a seismic attenuation (Q) tomography example, which is merely one embodiment. Others embodiments may include seismic velocity tomography or other geophysical properties.

Typically, the seismic attenuation tomography is utilized to find a subsurface model of Q (i.e. Q subsurface model) that is consistent with measured frequency content shift or amplitude decay in recorded seismic data. Examples of conventional seismic attenuation tomography are described in Quan et al. and Hu et al. See Hu, W., J. Liu, L. Bear, and C. Marcinkovich, A robust and accurate seismic attenuation tomography algorithm, SEG Expanded Abstracts 30, 2727 (2011); and Quan, Y. and J. M. Harris, Seismic attenuation tomography using the frequency shift method, Geophysics, 62, p. 895-905 (1997). These references describe the construction of subsurface model for attenuation based on the seismic traces.

In particular, assuming there are m recorded seismic traces associated with the measured centroid frequency shift Δf₁, . . . , Δfₘ. Δfᵢ is the centroid frequency shift along the i^{th} seismic trace. The measurement vector b=[b₁, . . . , bₘ]^{T} may be constructed using the following equation (e1):

$${b}_{i} = \frac{Δ {f}_{i}}{{f}_{0} {f}_{{R}_{i}}} , \qquad ( e 1 )$$

where f₀ is the characteristic frequency of the source amplitude frequency spectrum and f_{Ri} is the centroid frequency of the recorded seismic trace.

After discretization of the subsurface model (e.g., x from the equation (e3)), the inversion domain can be divided into n cells, the seismic attenuation parameter Q in each cell is assumed to be a constant value. Then, a seismic attenuation parameter vector may be represented as x=[1/Q₁, . . . , 1/Qₙ]^{T} and the m by n (m×n) kernel matrix A may be constructed, whose entries aᵢⱼ is defined by the following equation (e2):

$${a}_{ij} = \frac{π {l}_{ij}}{{v}_{j}} , \qquad ( e 2 )$$

where lᵢⱼ represent the i^{th} ray-path through the j^{th} cell of the subsurface model. Then, the seismic Q tomographic inversion equation can be written in the matrix form as equation (e3)

Ax=b. (e3)

This equation (e3) is solved for x. Because the measured data are contaminated by noise, the linear equation system (e3) is ill-conditioned and has non-unique solutions. Therefore, this system may be treated as a least square problem, and the approximate solution of the quadratic programming problem may be solved by via equation (e4):

min∥Ax−b∥, (e4)

where ∥ . . . ∥ denotes the Euclidean vector norm (i.e., ∥x∥=square root (x₁²+x₂²+ . . . +xₙ²)).

The optimization problem or tomographic inversion cost function of equation (e4) is the conventionally formulated tomographic inversion problem, which is also applicable for other geophysical property model building.

Mathematically, the entry aᵢⱼ in the kernel matrix A can be written as equation (e5):

$${a}_{ij} = \frac{\partial {b}_{i}}{\partial {x}_{j}} , \qquad ( e 5 )$$

whose physical meaning is the sensitivity of the i^{th} measurement to the 1/Q value in the j^{th} cell. Because aᵢⱼ is non-negative,

$${\sum }_{i} {a}_{ij}$$

is a measure of the total sensitivity of the data misfit to the j^{th} cell. With the conventional tomographic inversion cost function, which is expressed in equation (e4), apparently, the inversion sensitivity distribution

$${\sum }_{i} {a}_{ij}$$

is determined by the seismic ray density and the seismic velocity model, which is fixed as long as the seismic velocity model and the seismic survey geometry are given. Usually, seismic ray density may be very uneven, which implies highly non-uniform inversion sensitivity distribution. Consequently, the same amount of Q value correction for different cells may have different impacts on data misfit minimization. This phenomenon in seismic attenuation tomography is that the cells with high inversion sensitivity are over-corrected, while those with low sensitivity are under-corrected.

For certain applications, specific regions may be of interest, which may result in the method updating the geophysical properties in these regions, while still minimizing the data misfit. The conventional techniques implement the tomographic inversion locally (i.e., update the geophysical model parameters in the regions of interest, while fixing the model parameters in the remaining inversion domain). However, this type of implementation inevitably results in many artificial discontinuities. Further, in some circumstances, this approach may fail to converge and produce incorrect inversion results.

The present techniques provide a method that includes inversion sensitivity control techniques. With this method, the tomographic inversion sensitivity distribution is no longer determined solely by the ray density. Instead, the inversion sensitivity can be precisely controlled via users input or may be uniform.

For sensitivity-balanced tomographic inversion, the original tomographic inversion kernel matrix A (which is initially constructed) is converted to another matrix Â by applying a weighting matrix W, which is represented in the following equation (e6):

Â=WA, (e6)

where the weighting matrix W is a m×m diagonal matrix, which is derived by solving equation (e9). Therefore, the conventional tomographic inversion cost function, which is represented by equation (e4), is converted in equations (e7 and e8) as follows:

min∥Âx−\hat{b}∥, (e7)

where

\hat{b}=Wb. (e8)

Ideally, in noise-free and measurement-error-free cases, the equations (e7) and (e4) are equivalent because the true subsurface model of a geophysical property minimizes both equations (e4) and (e7) to zero (e.g., from an ideal physical point of view). However, in practical applications, the equations (e4) and (e7) are different because the inversion sensitivity distributions for these two inverse problems are different, i.e.,

$${\sum }_{i} {a}_{ij} \neq {\sum }_{i} {\hat{a}}_{ij}$$

as long as W is not an identity matrix, where âᵢⱼ the entry of the kernel matrix Â (e.g., from a mathematical point of view). A more uniform inversion sensitivity distribution may be preferred because uniformly distributed inversion sensitivity is able to mitigate the over-correction and under-correction issues. While the weighting matrix or scheme W may be determined manually by using a trial-and-error method to achieve a good sensitivity distribution, this approach may be inefficient and impractical as it may be time-consuming and uncontrollable.

With this present technique, the construction of the weighting scheme is directly or automatically computed utilizing the kernel matrix and the resulting sensitivity distribution may be nearly optimal (e.g., within a specific range or threshold). That is, the weighting scheme is calculated from the kernel matrix and is not manually specified by a user having to place weights on each seismic trace, which is subjective and based on the user's experience. The weighting scheme is obtained by solving another optimization problem, which is referred to as the sensitivity optimization problem, which is represented by equation (e9) and the following equations (e10) to e(13):

min∥Bv−d∥, (e9)

where B is called the adjoint sensitivity mapping matrix defined by the equation (e10):

$$B = [ \begin{matrix}{A}^{T} & - u \\ \frac{r}{m} a & 0\end{matrix} ] , \qquad ( e 10 )$$

v is the extended weighting vector defined by the equation (e11):

$$v = [ \begin{matrix}w \\ c\end{matrix} ] , \qquad ( e 11 )$$

d is the weight normalization vector defined by the equation (e12):

$$d = [ \begin{matrix}0 \\ r\end{matrix} ] , \qquad ( e 12 )$$

and the scaling factor r is defined by equation (e13):

$$r = \frac{1}{n} {\sum }_{i , j } {a}_{ij} . \qquad ( e 13 )$$

where m is the number of measurements and n is the number of cells in the model domain. A^{T} denotes the transpose of the kernel matrix A and w is the m×1 data weighting vector to be solved for, whose elements are the diagonal entries of weighting matrix W. c is an unknown constant to be inverted, while u is a n×1 column vector whose elements are 1 and a is a 1×m vector whose elements are 1.

The data weights are forced to be non-negative by solving the following constrained inversion equation (e14) instead of equation (e9):

min∥Bv−d∥ subject to v≧0. (e14)

With the solved sensitivity optimization problem, the weighting vector w is obtained and then the sensitivity-balanced tomographic inversion, which is represented as equation (e7), is solved instead of the conventional tomographic inversion represented by equation (e4), to reconstruct the Q subsurface model.

Beneficially, the inversion-based data weighting scheme for quantitative sensitivity control is developed and provides an enhanced subsurface model. Therefore, the sensitivity-balanced tomographic inversion algorithms do not focus on the regions associated with original high inversion sensitivity because of the data weighting scheme. That is, the geophysical property update is provided in an enhanced manner that does not overemphasize certain regions based on the data misfit minimization, which may result in the reconstructed geophysical properties (e.g., seismic velocity, seismic attenuation property Q, and/or etc.) being inaccurate or even wrong. Accordingly, with the present technique, a well-balanced sensitivity distribution can be achieved for global tomographic inversion.

In addition to the well-balanced sensitivity distribution, in certain embodiments the present techniques may be utilized to provide enhancements to subsurface model based on sensitivity controllable target-oriented tomography inversions. The method of applying the sensitivity control technique to target-oriented tomographic inversion is very similar to the sensitivity-balanced tomography, which is noted above. However, in the target-oriented sensitivity control technique of tomographic inversion, the adjoint sensitivity mapping matrix is different. For this technique, the adjoint sensitivity mapping matrix is defined by equation (e15) as follows:

$$B = [ \begin{matrix}{A}^{T} & - s \\ \frac{r}{m} a & 0\end{matrix} ] , \qquad ( e 15 )$$

where s is the targeted sensitivity distribution specified by users. In an effective target-oriented tomography, the designed sensitivity should be high in the regions of interest, while it should be much lower in the remaining regions of the domain. After constructing the adjoint sensitivity mapping matrix B, equation (e15) can be solved to obtain the weighting vector w. Then, by applying the weighting scheme on the original cost function in equation (e4), the sensitivity-controllable target-oriented inversion cost function (e7) is obtained and this optimization problem can be solved numerically to reconstruct the subsurface model of Q.

Beneficially, the present techniques provide an arbitrarily controllable sensitivity distribution that may be obtained for target-oriented tomographic inversion. In contrast to other techniques, which are noted above and may utilize simplified weights for datasets contributing to the target region, the present techniques quantitatively evaluate the contribution of the datasets. In other words, the present techniques quantitatively determine the weights of the data to achieve an enhanced sensitivity distribution. In addition, this method uses the original data for inversion, which limits the introduction of addition errors from approximations. Further, the present techniques may balance or quantitatively control the inversion sensitivity. In other words, the method can obtain any arbitrary sensitivity distribution accurately because the data weighting scheme is obtained by inversion (i.e., matrix inverse), not by back-propagation (i.e., matrix transpose). Further still, this method lessens artifacts because the method is based on a global inversion, not the merging of the target region to a global domain.

Both the sensitivity-balanced tomography and the sensitivity-controllable target-oriented tomography are two-step inversions (two cascaded inversions). Instead of inverting the subsurface model of geophysical property directly, the sensitivity optimization is implemented in the first step to invert the data weighting scheme for quantitative sensitivity control. Then, in the second step, the subsurface model of a geophysical property is inverted with the controlled inversion sensitivity. This approach provides the capability of quantitative sensitivity control, a two-step target-oriented tomography inversion method, and a data weighting scheme for sensitivity control that is designed by solving an optimization problem.

The sensitivity control technique utilizes the adjoint operator of the kernel matrix A to map the to-be-determined data weighting vector from the data domain to the model domain and then use the targeted sensitivity distribution, which may be user-specified, to construct a sensitivity optimization problem. The solution of this sensitivity optimization problem is utilized for optimally choosing and weighting the measurement data. For other geophysical property tomography, the kernel matrix may be different, but the method of sensitivity control may remain the same.

An alternative approach to derive the data weighting vector may include formulating and solving the following optimization problem:

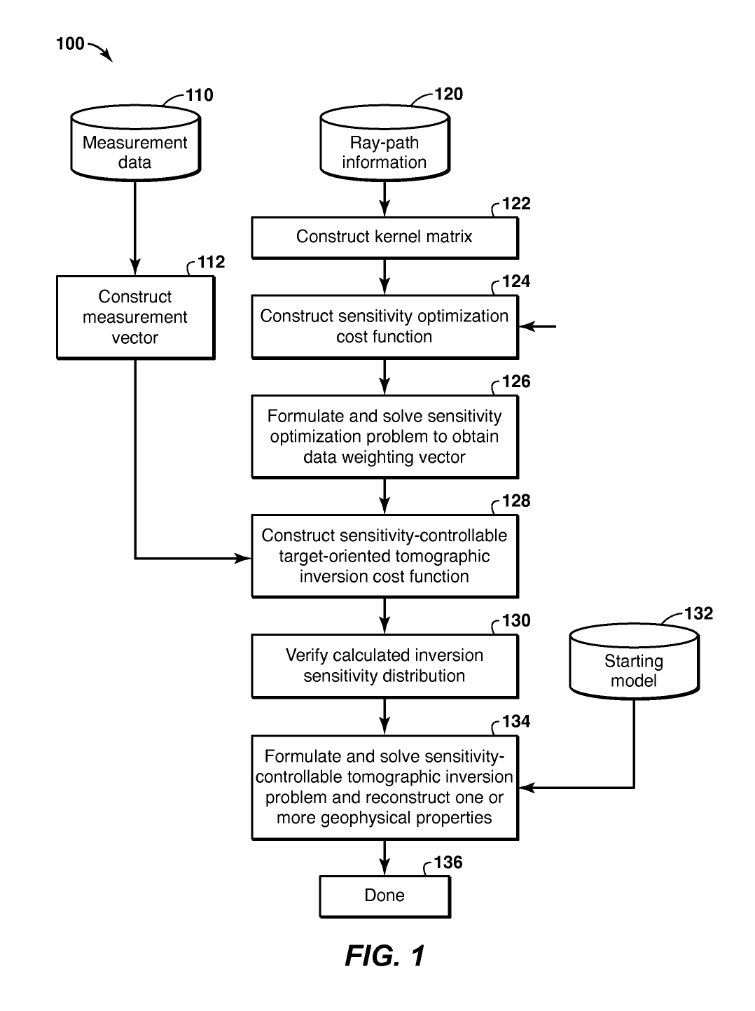

min∥A^{T}w−s∥, (e16)

where A^{T} denotes the transpose of the kernel matrix A and w is the m×1 data weighting vector to be solved for, whose elements are the diagonal entries of W. Similar to the data weighting vector noted above, this equation provides sensitivity-controllable target oriented tomography. Various aspects of the present techniques are described further in FIGS. 1 to 12.

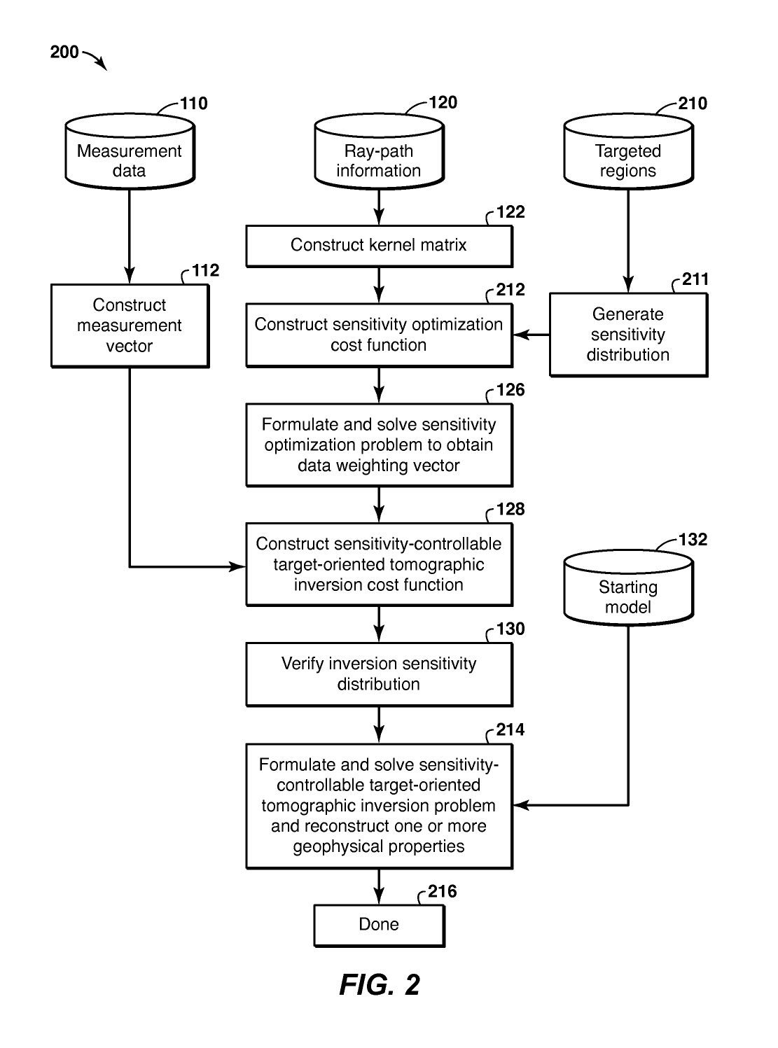

Certain embodiments of the present techniques may be implemented as a method, as described in the exemplary embodiments of a flow chart in FIGS. 1 and 2. FIG. 1 is a flow chart 100 for implementing sensitivity-balanced tomography in accordance with an exemplary embodiment of the present techniques. As noted above, this flow chart 100 includes an initial data and model preparation stage, which includes blocks 110, 112, 120 and 122, followed by a sensitivity optimization stage, which includes blocks 124 and 126, and followed by a property optimization stage, which includes blocks 128, 130, 132 and 134. Then, the resulting subsurface model may be further refined or utilized in block 136.

The process begins with the initial data and model preparation stage, which involves constructing the measurement vector and the kernel matrix. To construct the measurement vector, measurement data is obtained in block 110. The measurement data may be obtained by performing a seismic survey (e.g., forming seismic waves with a source, recording the received signals related to the source at one or more receivers, and processing received data to form measurement data. The measurement data may include surface seismic data, check-shot seismic data, etc. With the measurement data, the measurement vector is constructed in block 112. The construction of the measurement vector (e.g., b in equation e(3)) may include using the measurement data to create the measurement vector. For example, the measurement vector may be generated by each receiver being associated with an entry in the measurement vector.

In addition to the construction of the measurement vector, the initial data and model preparation stage also involves construction of a kernel matrix. To construct the kernel matrix, ray-path information is obtained in block 120. The ray-path information includes the length of each seismic ray segment through each cell of the subsurface model (e.g., lᵢⱼ in equation e(2)). With the ray-path information and the given seismic velocity model information (vⱼ in equation e(2), the kernel matrix may be constructed as shown in block 122. The construction of the kernel matrix (e.g., A in equation e(3)) may include using the ray-path information and the seismic velocity model by know methods (e.g., U.S. Pat. No. 7,675,818, which is incorporated by reference, further describes certain methods).

After the initial data and model preparation stage, the sensitivity optimization stage is performed, as noted in blocks 124 and 126. In block 124, the sensitivity optimization cost function is constructed. This construction of the sensitivity optimization cost function (which is represented by equation (e9)) may include transposing the kernel matrix to build the adjoint sensitivity mapping matrix (which is represented by equation (e10)). Further, the extended weighting vector v (e.g., note the equation (e11)); d is the weight normalization vector d (e.g., noted in equation (e12)) and the scaling factor r (e.g., noted in equation (e13)) may also be defined and solved. Then, at block 126, the sensitivity optimization cost function is formulated into a sensitivity optimization problem and the problem is solved to obtain the data weighting vector. As an example, the sensitivity optimization problem may be solved by minimizing the sensitivity optimization cost function. In solving the sensitivity optimization problem, a box-constraint or a non-negative constraint may be added in the optimization process to avoid negative and extremely large weights. Also, the optimization problem may be solved by using the conjugate gradient method or its variants.

After the sensitivity optimization stage is complete, the property optimization stage may be performed, which includes blocks 128, 130, 132 and 134. At block 128, the sensitivity-controllable tomographic inversion cost function is constructed (which may be referred to as sensitivity-balanced tomographic inversion cost function). The sensitivity-balanced tomographic inversion cost function is a specialized application of the sensitivity-controllable tomographic inversion cost function. That is, if the sensitivity distribution is uniform or unspecified, the sensitivity-controllable tomographic inversion cost function is the sensitivity-balanced tomographic inversion cost function. As an example, the sensitivity-balanced tomographic inversion cost function, which is represented by equation (e7)), may be constructed based on the measurement vector and the data weighting vector. For example, the sensitivity-balanced tomographic inversion cost function (e7) may be constructed by applying the data weighting vector with the measurement vector from block 112. That is, the data weighting vector may be modified to form the data weighting matrix (W in equation (e6)), which is applied to the constructed kernel matrix. Also, the data weighting vector may be applied to the measurement vector. Then, the determined components may be placed into the system of equation (e7) to be the sensitivity-controllable tomographic inversion cost function, which may be referred to as a sensitivity-balanced tomographic inversion cost function. At block 130, the calculated sensitivity distribution may be verified. The calculated sensitivity distribution (associated with Â in equation (e6)) may be verified by visual inspection or by mathematical operations. For example, the verification may include determining if the calculated sensitivity distribution is within a specific threshold. As another example, a user may visually inspect the distribution and determine that it should be modified. At block 132, a starting model is obtained, which may be specified by the users or provided from another source. The starting model may be a model of the subsurface volume associated with the measurement data and the ray-path information and one or more geophysical properties. Then, the sensitivity-controllable tomographic inversion cost function may be formulated as a sensitivity-controllable tomographic inversion problem (e.g., represented by equation (e7)) and solved, as shown in block 134. That is, the sensitivity-controllable tomographic inversion cost function (e.g., a sensitivity-balanced tomographic inversion cost function for certain applications of a uniform sensitivity distribution) may involve formulating the sensitivity-controllable tomographic inversion cost function into a sensitivity-controllable tomographic inversion problem. As an example, the sensitivity-balanced tomographic inversion problem may be solved by minimizing the sensitivity-balanced tomographic inversion cost function. The solving of the sensitivity-balanced tomographic inversion problem may include a box-constraint or a non-negative constraint to provide a subsurface model of the geophysical property. The optimization problem may be solved by using the conjugate gradient method or its variants. Also, a regularization term may be added to the cost function to stabilize the optimization process.

Once the property optimization stage is performed, the subsurface model of the geophysical property may be updated or utilized to recovery resources. If the subsurface model does not satisfy the expected requirements, the starting model may be redefined and the sensitivity-controllable tomographic inversion problem is resolved in block 134. The requirements may include user determination that the model is not reasonable (e.g., does not conform with geology understanding from previous model, well logs or other sources.

To provide target oriented functionality, the tomographic sensitivity in the region of interest needs to be boosted to a certain level in comparison with the remaining region. In order to boost the sensitivity in the targeted region in a controlled manner, the process flow of FIG. 1 may be modified to further enhance the resulting subsurface model of the geophysical property, which is described further in FIG. 2. FIG. 2 is another flow chart 200 for implementing sensitivity-controllable target-oriented tomography in accordance with an exemplary embodiment of the present techniques. In this flow chart 200, various blocks may be performed similar to those noted above in FIG. 1. However, in this flow chart 200, the sensitivity optimization stage includes additional blocks 210, 211 and 212 and the property optimization stage includes blocks 214 and 216.

After the initial data and model preparation stage performs blocks 110, 112, 120 and 122, the sensitivity optimization stage performs blocks 210, 211, 212, and 126. In block 210, target regions are obtained. The obtaining of target regions may include identifying the location and/or geometry from the seismic velocity model, well logs, previous models or other suitable sources. At block 211, the targeted sensitivity distribution (e.g., s in equation (e15)) is generated. This may involve a user determining a specific region to adjust the sensitivity. In block 212, the sensitivity optimization cost function is constructed. While the construction of the sensitivity optimization cost function may be similar to block 124 of FIG. 1, this construction of the sensitivity optimization cost function is based at least partially on the designed sensitivity distribution, which are generated in block 211. This construction may include transposing the kernel matrix to build the adjoint sensitivity mapping matrix (in equation (e15)), which is used in the sensitivity optimization cost function. Further, the extended weighting vector v (e.g., note the equation (e11)); d is the weight normalization vector d (e.g., noted in equation (e12)) and the scaling factor r (e.g., noted in equation (e13)) may also be defined and solved. However, in these equations, s is the targeted sensitivity distribution specified by users. Then, at block 126, the data weighting vector is determined. This determination may be similar to the discussion of block 126 in FIG. 1.

After the sensitivity optimization stage is performed, the property optimization stage performs blocks 128, 130, 132 and 214. At block 128, the sensitivity-controllable tomographic inversion cost function (which is represented in equation (e7)) is constructed. At blocks 130 and 132, the calculated sensitivity distribution may be verified and a starting model is obtained. Then, the sensitivity-controllable target-oriented tomographic inversion problem (e.g., minimizing equation (e7)) is formulated from the sensitivity-controllable target-oriented tomographic inversion cost function and solved, as shown in block 214. The solving of the sensitivity-controllable target-oriented tomographic inversion problem may include minimizing the sensitivity-controllable target-oriented tomographic inversion cost function and may include a box-constraint or a non-negative constraint to provide a subsurface model of the geophysical property. The optimization problem may be solved by using the conjugate gradient method or its variants. Also, a regularization term may be added to the cost function to stabilize the optimization process.

Once the property optimization stage is performed, the subsurface model of the geophysical property may be updated or utilized to recovery resources. If the reconstructed subsurface model does not satisfy the expected requirements, the starting model can be redefined and block 214 is the sensitivity-controllable target-oriented tomographic inversion problem may be solved again. This determination of satisfying the expected requirements may be based on review and visual inspection by a user, as an example. This may include models that do not appear to conform the previous models, are inconsistent with predicted geology and/or the like. As another alternative or in addition to modifying the starting model, the sensitivity distribution can be redefined and then blocks 212, 126, 128, 130, 214 may be performed again with the updated sensitivity distribution.

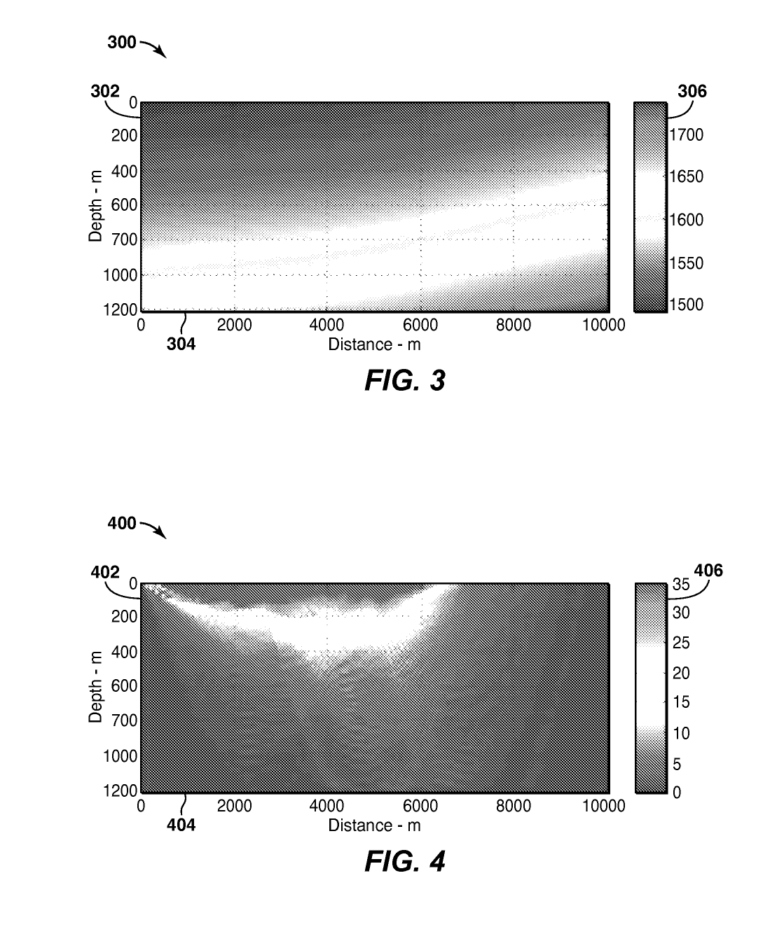

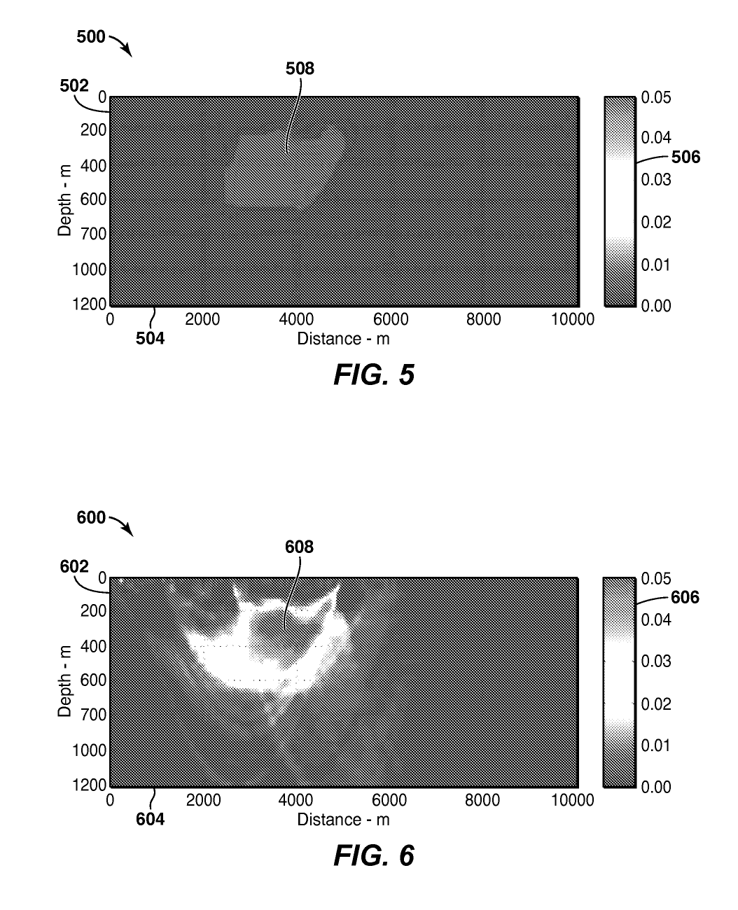

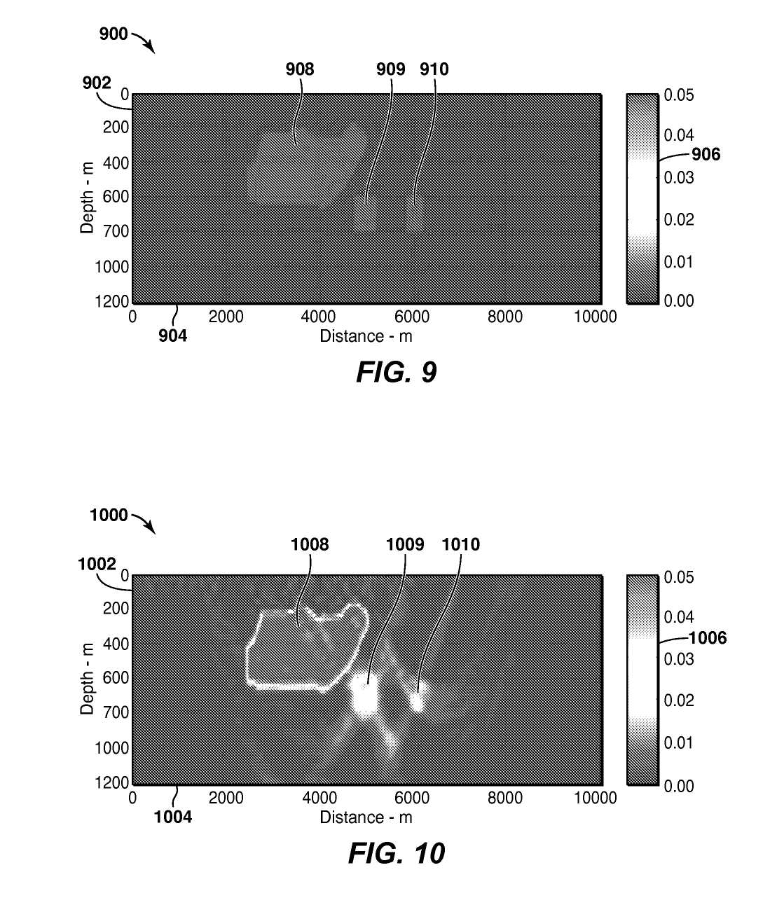

To further clarify the present techniques, synthetic examples of sensitivity-balanced Q tomography and sensitivity-controllable target-oriented Q tomography are presented, which are compared with the conventional tomography algorithms, as noted in the FIGS. 3 to 12. In these figures, FIG. 3 illustrates a seismic velocity model, FIG. 4 illustrates an original sensitivity distribution associated with the original kernel matrix (e.g., A in equation (e3)), FIGS. 5-8 illustrate different models and sensitivity distribution from a first example, and FIGS. 9-12 illustrate different models and sensitivity distribution from a second example. In these figures, variation in property values (parameters) is indicated by color scale, which is described for each figure. The color scale includes colors from red to blue (e.g., red, orange, yellow, green, and blue) with the red indicating a higher value compared to blue.

A first example is presented to show the sensitivity balancing effect and its impact on final tomography results. In particular, FIG. 3 is an exemplary graph 300 of the true seismic velocity model, which is used to obtain the ray-path information (e.g., ray-path information of block 120 in FIG. 1 or 2). In this model, the depth of the subsurface volume is shown along the axis 302 in meters (m) and distance is shown along axis 304 in meters (m). Further, the seismic velocity is shown in meters per second (m/s) in the scale 306, which has red color associated with valves of about 1725 m/s and blue color associated with values of about 1500 m/s. Due to patent law restrictions on use of color, FIGS. 3-12 are black and white reproductions of color drawings. As shown in this model, the seismic velocity increases from the shallow depths (e.g., 200 m to 400 m) to the deeper depths (e.g., 1000 m to 1200 m) along the axis 302 and also has a slight increase from distances from 0 to 2000 m to 8000 m to 10000 m along the axis 304.

FIG. 4 is an exemplary graph 400 of the original sensitivity distribution associated with the original kernel matrix (A in equation e(3)). In this distribution, the depth of the subsurface volume is shown along the axis 402 in meters (m) and distance is shown along axis 404 in meters (m). Further, the sensitivity is shown along the scale 406, which does not have units and has the red color associated with valves of about 35 and blue color associated with values of about 0. The original sensitivity distribution is determined by the given shot/receiver geometry and the true seismic velocity model. As shown in this distribution, the near surface sensitivity (e.g., 0 m to 400 m along the axis 402 and for the depths of 0 m to about 7000 m along the axis 404) is higher compared to the deeper regions (e.g., 400 m to 1200 m along the axis 402 and for the depths of 0 m to about 7000 m along the axis 404).

FIG. 5 is an exemplary graph 500 of the true 1/Q model. In this model, the depth of the subsurface volume is shown along the axis 502 in meters (m) and distance is shown along axis 504 in meters (m). Further, the attenuation parameter is shown in 1/Q in the scale 506, which has the red color associated with valves of about 0.05 and blue color associated with values of about 0. As shown in this 1/Q model, an anomaly 508 is located between depths in the range of 200 m and 800 m and distances in the range of 2000 m and 6000 m. This true 1/Q model along with the true seismic velocity model of FIG. 3, and the source/receiver geometry are input to a seismic wave propagation simulation model to generate a synthetic seismic dataset (as noted in block 110 of FIG. 1) to be used for the Q tomographic inversion.

FIG. 6 is an exemplary graph 600 of the reconstructed 1/Q model using conventional tomography algorithm (e.g., equation (e4)) and associated with the original sensitivity distribution shown in FIG. 4) and inverting the above mentioned synthetic seismic dataset generated by using the true 1/Q model shown in FIG. 5. In this model, the depth of the subsurface volume is shown along the axis 602 in meters (m) and distance is shown along axis 604 in meters (m). Further, the attenuation is shown in the scale 606 in units of 1 per Q, which has the red color associated with valves of about 0.05 and the blue color associated with values of about 0. As shown in this model, a reconstructed anomaly 608 is located between depths in the range of 50 m and 800 m and distances in the range of 2000 m and 6000 m. The geometry in the lower region of the anomaly 608 (e.g., below 400 m) is not reconstructed accurately and the 1/Q values are under-corrected due to the low sensitivity in this region, as indicated in FIG. 4.

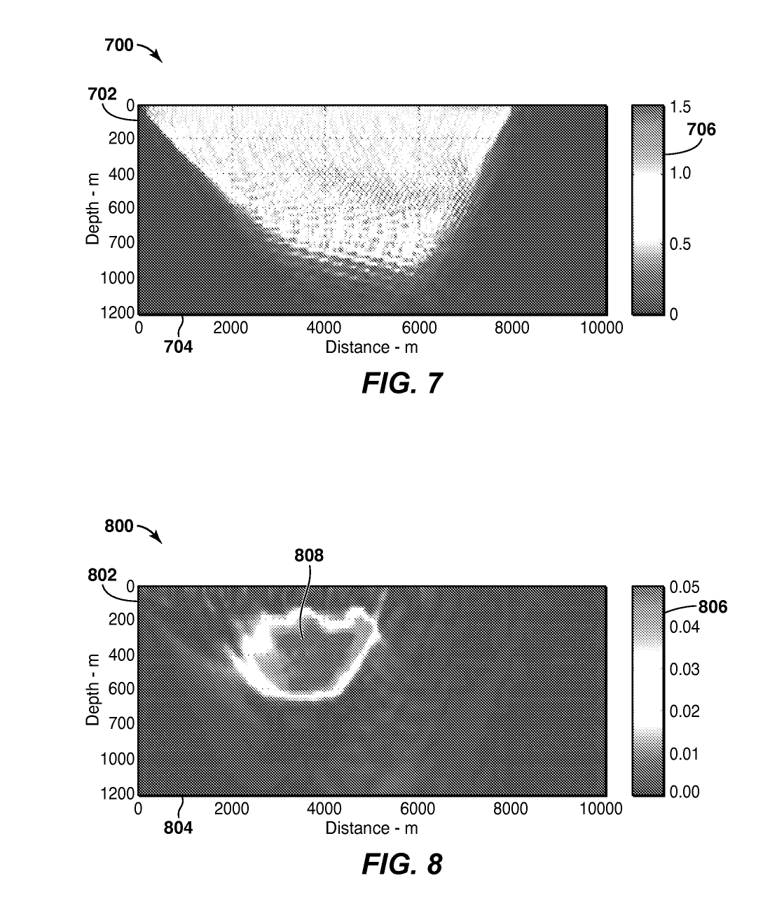

FIG. 7 is an exemplary graph 700 of the balanced sensitivity distribution associated with the converted kernel matrix (e.g., in equation (e6)) (block 130 in FIG. 1) according to an embodiment of the present techniques. In this distribution, the depth of the subsurface volume is shown along the axis 702 in meters (m) and distance is shown along axis 704 in meters (m). Further, the sensitivity associated with the converted kernel matrix is shown in the scale 706, which does not have units and has the red color associated with values of about 1.5 and blue color associated with values of about 0. As shown in this distribution, the tomographic inversion sensitivity is well balanced by using the sensitivity control technique. In fact, the sensitivity is distributed over a region from 0 m to 1000 m along the axis 702 and for the depths of 0 m to about 8000 m along the axis 704. This sensitivity distribution validates that the present techniques may be used to balance the sensitivity distribution in an enhanced manner.

FIG. 8 is an exemplary graph 800 of the reconstructed 1/Q model obtained with the sensitivity-balanced tomography algorithm (e.g., in equation (e7)) inverting the synthetic seismic dataset by using the balanced sensitivity distribution shown in FIG. 7 according to an embodiment of the present techniques. In this model (obtained by performing block 134 in FIG. 1), the depth of the subsurface volume is shown along the axis 802 in meters (m) and distance is shown along axis 804 in meters (m). Further, the attenuation is shown in the scale 806 in units of 1 per Q, which has the red color associated with valves of about 0.05 and blue color associated with values of about 0. As shown in this reconstructed 1/Q model associated with the balanced sensitivity distribution shown in FIG. 7, a reconstructed anomaly 808 is the is located between depths in the range of 200 m and 700 m and distances in the range of 2000 m and 6000 m. The geometry of the anomaly 808 is reconstructed in a more accurate manner in comparison to the anomaly 608 of FIG. 6. That is, the sensitivity-balanced Q tomography result shows that the geometry and the 1/Q values of the Q anomaly are better reconstructed in comparison with the conventional tomography algorithm.

A second example is presented to show the sensitivity-controllable target-oriented tomography and its impact on final tomography results. The seismic velocity model is the same as the first example. Therefore, the original sensitivity distribution remains the same because the same shot/receiver geometry is utilized.

FIG. 9 is an exemplary graph 900 of the true 1/Q model. In this model, the depth of the subsurface volume is shown along the axis 902 in meters (m) and distance is shown along axis 904 in meters (m). Further, the attenuation is shown in 1/Q in the scale 906, which has the red color associated with valves of about 0.05 and blue color associated with values of about 0. As shown in this model, an anomaly 908 is located between depths in the range of 200 m and 800 m and distances in the range of 2000 m and 6000 m, which is same as the anomaly 508 of FIG. 5. Further, a second anomaly 909 is located between depths in the range of 600 m and 900 m and distances in the range of 4000 m and 6000 m, while a third anomaly 910 is located between depths in the range of 600 m and 900 m and distances in the range of 6000 m and 7000 m. The additional smaller Q anomalies 909 and 910 are buried in the deeper region below the surface. This true 1/Q model, the true seismic velocity model of FIG. 3, and the source/receiver geometry are input to a seismic wave propagation simulation model to generate a synthetic seismic dataset to be used for the Q tomographic inversion (as noted in block 110 of FIG. 2).

Accordingly, assuming the shallow Q anomaly is known and it is used as the starting model, two simulations are performed and the resulting models are shown in FIGS. 10 and 12. FIG. 10 is an exemplary graph 1000 of the reconstructed 1/Q model using sensitivity-balanced tomography algorithm (e.g., from equation (e7), block 134 in FIG. 1) and inverting the above mentioned synthetic seismic dataset with the starting model shown in FIG. 5 and the sensitivity distribution shown in FIG. 7. In this model, the depth of the subsurface volume is shown along the axis 1002 in meters (m) and distance is shown along axis 1004 in meters (m). Further, the attenuation is shown in the scale 1006 in units of 1 per Q, which has the red color associated with valves of about 0.05 and blue color associated with values of about 0. In this simulation, a balanced sensitivity, which is the sensitivity utilized in FIG. 7, is used to generate this 1/Q model. As shown in this model (obtained by performing block 134 in FIG. 1), a reconstructed anomaly 1008 is located between depths in the range of 50 m and 800 m and distances in the range of 2000 m and 6000 m. The other anomalies 1009 and 1010 are partially indicated in the range of 600 m and 800 m and distances in the range of 4000 m and 7000 m. The two small Q anomalies 1009 and 1010 are partially resolved, but both the geometry and the 1/Q values are not accurate. As such, the balanced sensitivity may not be enough for good reconstruction quality in certain instances.

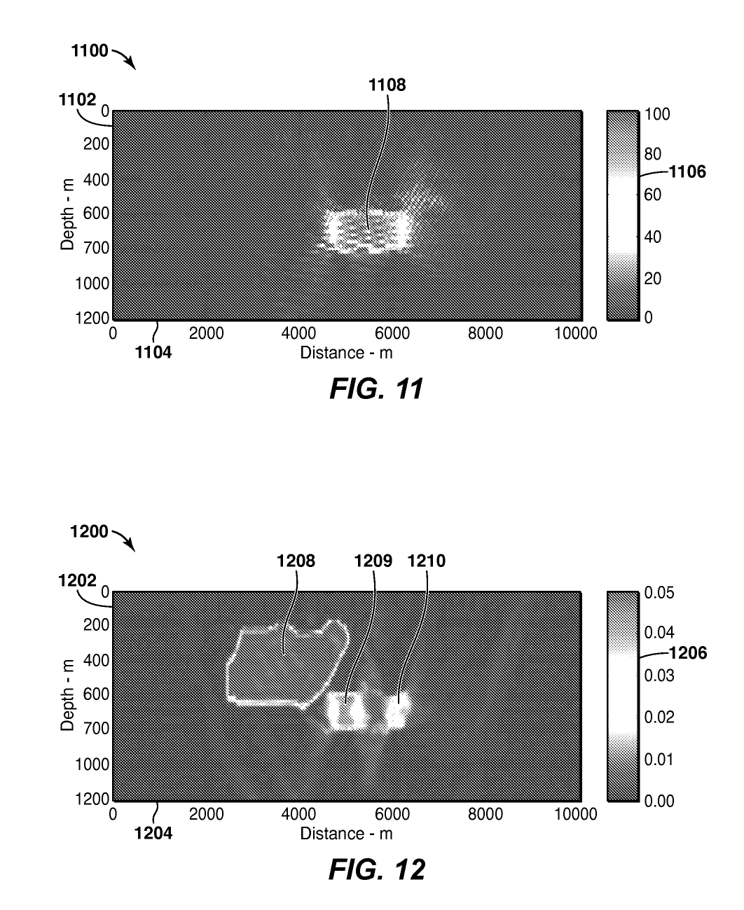

As target-oriented tomography may enhance the model, a second simulation is performed. In the second simulation, the sensitivity in the region of interest is boosted with the sensitivity control techniques noted above. FIG. 11 is an exemplary graph 1100 of the boosted sensitivity distribution (e.g., obtained by performing block 210, 211, 212, 128 in FIG. 2) for target-oriented tomography according to an embodiment of the present techniques. In this distribution, the depth of the subsurface volume is shown along the axis 1102 in meters (m) and distance is shown along axis 1104 in meters (m). Further, the sensitivity associated with the converted kernel matrix (e.g., from equation (e6) or block 130) is shown in the scale 1106, which does not have units, which has the red color associated with valves of about 100 and blue color associated with values of about 0. As shown in this distribution, the tomographic inversion sensitivity is focused on the target region 1108 by using the target oriented sensitivity control technique. In fact, the sensitivity is distributed over a region 1108 for depths from 600 m to 800 m along the axis 1102 and for the distances in the range of about 5000 m to about 8000 m along the axis 1104. This sensitivity distribution validates that the present techniques may be used to precisely controlling the sensitivity distribution to be close to the user-specified sensitivity distribution.

FIG. 12 is an exemplary graph 1200 of the reconstructed 1/Q model obtained with the sensitivity-controllable target-oriented tomography algorithm (e.g., equation (e7)) and inverting the synthetic seismic dataset by using the boosted sensitivity distribution shown in FIG. 11 and with the starting model shown in FIG. 5 in accordance with the present techniques. In this model, the depth of the subsurface volume is shown along the axis 1202 in meters (m) and distance is shown along axis 1204 in meters (m). Further, the attenuation is shown in the scale 1206 in units of 1 per Q, which has the red color associated with valves of about 0.05 and blue color associated with values of about 0. As shown in this model, a reconstructed anomaly 1208 is the is located between depths in the range of 200 m and 700 m and distances in the range of 2000 m and 5000 m. Also, the additional reconstructed anomalies 1209 and 1210 are located between depths in the range of 600 m and 800 m and distances in the range of 5000 m and 7000 m. The geometry of the anomalies 1208, 1209 and 1210 are reconstructed in a more accurate manner in comparison to the anomalies 1008, 1009 and 1010 of FIG. 10. That is, the sensitivity-controllable target-oriented Q tomography result shows that the geometry and the Q values of the Q anomalies are better reconstructed in comparison with the sensitivity-balanced tomography algorithm.

Further, in one or more embodiments, the present techniques may be utilized to produce hydrocarbons from a subsurface volume. For example, a method may include obtaining seismic data from a seismic survey of the subterranean or subsurface volume; obtaining a subsurface model for the subsurface volume for at least one geophysical property, the subsurface model being generated by: (a) constructing a measurement vector from seismic data; (b) constructing a kernel matrix from ray-path information; (c) constructing a sensitivity optimization cost function based on the kernel matrix; (d) deriving data weighting vector by minimizing the sensitivity optimization cost function; (e) constructing a sensitivity-controllable tomographic inversion cost function by applying the data weighting vector; (f) obtaining a starting subsurface model; and (g) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function; imaging the seismic data using the subsurface model of the geophysical property; and drilling at least one well to the subsurface volume (e.g., a formation) indicated in the image; and producing hydrocarbons from the subsurface volume or formation. Further, the step (c) of the method may include obtaining a targeted sensitivity distribution and using the targeted sensitivity distribution with the kernel matrix to construct the sensitivity optimization cost function.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

Further, one or more embodiments may include methods that are performed by executing one or more sets of instructions to perform modeling enhancements in various stages. For example, the method may include performing a preparation stage to construct a measurement vector from seismic data and a kernel matrix from ray-path information; performing a sensitivity optimization stage to generate a data weighting vector; and performing a property optimization stage to reconstruct a subsurface model of one or more geophysical properties.

As an example, a computer system may be utilized and configured to implement one or more of the present aspects. The computer system may include a processor; memory in communication with the processor; and a set of instructions stored on the memory and accessible by the processor, wherein the set of instructions, when executed, are configured to: obtain a measurement vector and a kernel matrix; construct a sensitivity optimization cost function based on the kernel matrix; calculate a data weighting vector by minimizing the sensitivity optimization cost function; construct a sensitivity-controllable tomographic inversion cost function by applying the data weighting vector; obtain a starting subsurface model; and produce a subsurface model of a geophysical property by solving a sensitivity-controllable tomographic inversion problem with the starting subsurface model, wherein the sensitivity-controllable tomographic inversion problem is based on the sensitivity-controllable tomographic inversion cost function. The computer system may also include a set of instructions that is configured to obtain a targeted sensitivity distribution and to construct the sensitivity optimization cost function from the targeted sensitivity distribution with the kernel matrix.

Other embodiments are described in the following numbered statements:

1. A computer-implemented method for constructing a subsurface model of a subsurface volume from seismic data or other suitable data for a geophysical property, comprising: (a) constructing a measurement vector from seismic data; (b) constructing a kernel matrix from ray-path information; (c) constructing a sensitivity optimization cost function based on the kernel matrix; (d) deriving data weighting vector by minimizing the sensitivity optimization cost function; (e) constructing a sensitivity-controllable tomographic inversion cost function by applying the data weighting vector; (f) obtaining a starting subsurface model; and (g) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function.
2. The method of paragraph 1, wherein the step (c) comprising obtaining a targeted sensitivity distribution and using the targeted sensitivity distribution with the kernel matrix to construct the sensitivity optimization cost function.
3. The method of any of paragraphs 1 to 2, wherein the step (c) comprises transposing the kernel matrix to build an adjoint sensitivity mapping matrix that is utilized to construct the sensitivity optimization cost function.
4. The method of any one of the paragraphs 2 to 3 wherein the targeted sensitivity distribution is designed to have high sensitivity in the region of interest and to have low sensitivity in the remaining region.
5. The method of any one of paragraphs 1 to 4, wherein the step (d) comprises using the conjugate gradient method or its variants to minimize the sensitivity optimization cost function.
6. The method of any one of paragraphs 1 to 5, wherein the step (d) comprises adding a box-constraint or a non-negative constraint in the deriving the data weighting vector from the sensitivity optimization cost function.
7. The method of paragraphs 1 to 6, wherein the step (d) comprises formulating a sensitivity optimization problem from the sensitivity optimization cost function and solving the sensitivity optimization problem, which is represented by the following equation:

min∥Bv−d∥,

where B is called the adjoint sensitivity mapping matrix defined by the following equation:

$$B = [ \begin{matrix}{A}^{T} & - u \\ \frac{r}{m} a & 0\end{matrix} ] ,$$

v is the extended weighting vector defined by the following equation:

$$v = [ \begin{matrix}w \\ c\end{matrix} ] ,$$

d is the weight normalization vector defined by the following equation:

$$d = [ \begin{matrix}0 \\ r\end{matrix} ] ,$$

and the scaling factor r is defined by the following equation:

$$r = \frac{1}{n} {\sum }_{i , j } {a}_{ij} .$$

where m is the number of measurements and n is the number of cells in the model domain, A^{T} denotes the transpose of the kernel matrix A and w is the m×1 data weighting vector to be solved for, whose elements are the diagonal entries of W, c is an unknown constant to be inverted, v is greater than and equal to 0, u is a n×1 column vector whose elements are 1 and a is a 1×m vector whose elements are 1.
8. The method of any of the paragraphs 1 to 7, wherein step (b) comprises performing ray tracing to obtain the kernel matrix.
9. The method of any one of paragraphs 1 and 8, wherein step (b) comprises developing a linear system of tomographic equations expressed in the kernel matrix as the form as Ax=b, where x is a vector whose components parameterize the subsurface model of the geophysical property in a first representation of the subsurface volume, b contains information derived from measured data representative of the subsurface volume and sensitive to the geophysical property, and A relates the geophysical property within the subsurface volume to the data.
10. The method of paragraph 9, where b contains information derived from seismic or seismic-derived data.
11. The method of any one of paragraphs 1 and 10, wherein the data weighting vector is nearly optimal.
12. The method of any one of paragraphs 1 and 11, wherein step (e) comprises modifying the kernel matrix and the measurement vector based on the data weighting vector to construct the sensitivity-controllable tomographic inversion cost function.
13. The method of paragraph 12, wherein step (e) comprises creating a weighting matrix from the data weighting vector and applying the weighting matrix to the kernel matrix and utilizing the weighted kernel matrix to construct the sensitivity-controllable tomographic inversion cost function.
14. The method of any one of paragraphs 12 to 13, wherein step (e) comprises applying the data weighting vector to the measurement vector and utilizing the weighted measurement vector to construct the sensitivity-controllable tomographic inversion cost function.
15. The method of any one of paragraphs 1 to 14, wherein the geophysical properties are one or more of (i) velocity; (ii) velocity anisotropy parameters; and (iii) seismic attenuation (Q).
16. The method of any one of paragraphs 1 to 15, further comprising: (h) determining whether the subsurface model satisfies a threshold; (i) if the subsurface model does not satisfy a design requirements, then (1) modifying the starting model and (2) repeating steps (c)-(g) generate the subsurface model; and (j) if the subsurface model does satisfy the design requirements, then storing the subsurface model in the memory of a computer system.
17. The method of any of paragraphs 1 to 16, where the seismic data are surface seismic data and/or check-shot seismic data.
18. A computer-implemented method for constructing a subsurface model of a subsurface volume from seismic data for a geophysical property, comprising: (a) constructing a measurement vector from seismic data; (b) constructing a kernel matrix from ray-path information; (c) constructing a sensitivity optimization cost function based from the kernel matrix and on a sensitivity distribution; (d) deriving data weighting vector by minimizing the sensitivity optimization cost function; (e) constructing a sensitivity-controllable tomographic inversion cost function by applying the data weighting vector; (f) obtaining a starting subsurface model; and (g) generating a subsurface model of the geophysical property by solving the sensitivity-controllable tomographic inversion problem with the starting subsurface model, wherein the sensitivity-controllable tomographic inversion problem is based on the sensitivity-controllable tomographic inversion cost function.
19. The method of paragraph 18, wherein the step (c) comprises transposing the kernel matrix to build an adjoint sensitivity mapping matrix that is utilized to construct the sensitivity optimization cost function.
20. The method of any one of the paragraphs 18 to 19, wherein the targeted sensitivity distribution is designed to have high sensitivity in the region of interest and to have low sensitivity in the remaining region.
21. The method of any one of paragraphs 18 to 20, wherein the step (d) comprises formulating a sensitivity optimization problem from the sensitivity optimization cost function and solving the sensitivity optimization problem, which is represented by the following equation:

min∥Bv−d∥,

where B is called the adjoint sensitivity mapping matrix defined by the following equation:

$$B = [ \begin{matrix}{A}^{T} & - s \\ \frac{r}{m} a & 0\end{matrix} ] ,$$

v is the extended weighting vector defined by the following equation:

$$v = [ \begin{matrix}w \\ c\end{matrix} ] ,$$

d is the weight normalization vector defined by the following equation:

$$d = [ \begin{matrix}0 \\ r\end{matrix} ] ,$$

and the scaling factor r is defined by the following equation:

$$r = \frac{1}{n} {\sum }_{i , j } {a}_{ij} .$$

where m is the number of measurements and n is the number of cells in the model domain, A^{T} denotes the transpose of the kernel matrix A and w is the m×1 data weighting vector to be solved for, whose elements are the diagonal entries of W, c is an unknown constant to be inverted, v is greater than and equal to 0, s is the targeted sensitivity distribution and a is a 1×m vector whose elements are 1.
22. The method of any one of paragraphs 18 to 20, wherein the step (d) comprises formulating a sensitivity optimization problem from the sensitivity optimization cost function and solving the sensitivity optimization problem, which is represented by the following equation:

min∥A^{T}w−s∥,

where A^{T} denotes the transpose of the kernel matrix A and w is the m×1 data weighting vector to be solved for, whose elements are the diagonal entries of W.
23. The method of any one of paragraphs 18 to 20, wherein the step (d) comprises using the conjugate gradient method or its variants to minimize the sensitivity optimization cost function.
24. The method of any one of paragraphs 18 to 23, wherein the step (d) comprises adding a box-constraint or a non-negative constraint in the deriving the data weighting vector from the sensitivity optimization cost function.
25. The method of any one of paragraphs 18 to 24, wherein the geophysical properties are one or more of (i) velocity; (ii) velocity anisotropy parameters; and (iii) seismic attenuation (Q).
26. A method for producing hydrocarbons from a subsurface region, comprising: (a)

obtaining seismic data from a survey of the subsurface volume; (b) obtaining a subsurface model for the subsurface volume of a one or more geophysical properties, the subsurface model being generated by: (i) constructing a measurement vector from seismic data; (ii) constructing a kernel matrix from ray-path information; (iii) constructing a sensitivity optimization cost function based on the kernel matrix; (iv) deriving data weighting vector by minimizing the sensitivity optimization cost function; (v) constructing a sensitivity-controllable tomographic inversion cost function by applying the data weighting vector; (vi) obtaining a starting subsurface model; and (vii) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function; (c) imaging the seismic data using the subsurface model; (d) drilling at least one well to the subsurface volume in a formation based on the seismic image; and (e) producing hydrocarbons from the formation.

27. The method of paragraph 26, wherein the step (iii) comprising obtaining a targeted sensitivity distribution and using the targeted sensitivity distribution with the kernel matrix to construct the sensitivity optimization cost function.
28. The method of any of paragraphs 26 to 27, wherein the step (iii) comprises transposing the kernel matrix to build an adjoint sensitivity mapping matrix that is utilized to construct the sensitivity optimization cost function.
29. The method of any one of the paragraphs 27 to 28, wherein the targeted sensitivity distribution is designed to have high sensitivity in the region of interest and to have low sensitivity in the remaining region.
30. A computer system comprising: a processor; memory in communication with the processor; and a set of instructions stored on the memory and accessible by the processor, wherein the set of instructions, when executed, are configured to obtain a measurement vector and a kernel matrix; construct a sensitivity optimization cost function based on the kernel matrix; calculate a data weighting vector by minimizing the sensitivity optimization cost function; construct a sensitivity-controllable tomographic inversion cost function by applying the data weighting vector; obtain a starting subsurface model; and produce a subsurface model of a geophysical property solving a sensitivity-controllable tomographic inversion problem with the starting subsurface model, wherein the sensitivity-controllable tomographic inversion problem is based on the sensitivity-controllable tomographic inversion cost function.
31. The computer system of paragraph 30, wherein the set of instructions is configured to obtain a targeted sensitivity distribution and to construct the sensitivity optimization cost function from the targeted sensitivity distribution with the kernel matrix.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

1. A computer-implemented method for constructing a subsurface model of a subsurface volume from seismic data for a geophysical property, comprising:
(a) constructing a measurement vector from seismic data;
(b) constructing a kernel matrix from ray-path information;
(c) constructing a sensitivity optimization cost function based on the kernel matrix;
(d) deriving data weighting vector by minimizing the sensitivity optimization cost function;
(e) constructing a sensitivity-controllable tomographic inversion cost function by applying the data weighting vector;
(f) obtaining a starting subsurface model; and
(g) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function.

2. The method of claim 1, wherein the step (c) comprises obtaining a targeted sensitivity distribution and using the targeted sensitivity distribution with the kernel matrix to construct the sensitivity optimization cost function.

3. The method of any of claim 1, wherein the step (c) comprises transposing the kernel matrix to build an adjoint sensitivity mapping matrix that is utilized to construct the sensitivity optimization cost function.

4. The method claim 2, wherein the targeted sensitivity distribution is designed to have high sensitivity in a region of interest and to have low sensitivity in the remaining region.

5. The method of claim 1, wherein the step (d) comprises using the conjugate gradient method or its variants to minimize the sensitivity optimization cost function.

6. The method of claim 1, wherein the step (d) comprises adding a box-constraint or a non-negative constraint in the deriving the data weighting vector from the sensitivity optimization cost function.

7. The method of claim 1, wherein the step (d) comprises formulating a sensitivity optimization problem from the sensitivity optimization cost function and solving the sensitivity optimization problem, which is represented by the following equation:
min∥Bv−d∥,
where B is called the adjoint sensitivity mapping matrix defined by the following equation:
$$B = [ \begin{matrix}{A}^{T} & - u \\ \frac{r}{m} a & 0\end{matrix} ] ,$$
v is the extended weighting vector defined by the following equation:
$$v = [ \begin{matrix}w \\ c\end{matrix} ] ,$$
d is the weight normalization vector defined by the following equation:
$$d = [ \begin{matrix}0 \\ r\end{matrix} ] ,$$
and the scaling factor r is defined by the following equation:
$$r = \frac{1}{n} {\sum }_{i , j } {a}_{ij} .$$
where m is the number of measurements and n is the number of cells in the model domain, A^{T} denotes the transpose of the kernel matrix A and w is the m×1 data weighting vector to be solved for, whose elements are the diagonal entries of W, c is an unknown constant to be inverted, v is greater than and equal to 0, u is a n×1 column vector whose elements are 1 and a is a 1×m vector whose elements are 1.

8. The method of claim 1, wherein step (b) comprises performing ray tracing to obtain the kernel matrix.

9. The method of claim 1, wherein step (b) comprises developing a linear system of tomographic equations expressed in the kernel matrix as the form as Ax=b, where x is a vector whose components parameterize the subsurface model of the geophysical property in a first representation of the subsurface volume, b contains information derived from measured data representative of the subsurface volume and sensitive to the geophysical property, and A relates the geophysical property within the subsurface volume to the data.

10. The method of claim 9, where b contains information derived from seismic or seismic-derived data.

11. The method of claim 1, wherein the data weighting vector is nearly optimal.

12. The method of claim 1, wherein step (e) comprises modifying the kernel matrix and the measurement vector based on the data weighting vector to construct the sensitivity-controllable tomographic inversion cost function.

13. The method of claim 12, wherein step (e) comprises creating a weighting matrix from the data weighting vector and applying the weighting matrix to the kernel matrix and utilizing the weighted kernel matrix to construct the sensitivity-controllable tomographic inversion cost function.

14. The method of claim 12, wherein step (e) comprises applying the data weighting vector to the measurement vector and utilizing the weighted measurement vector to construct the sensitivity-controllable tomographic inversion cost function.

15. The method of claim 1, wherein the geophysical properties are one or more of (i) velocity; (ii) velocity anisotropy parameters; and (iii) seismic attenuation (Q).

16. The method of claim 1, further comprising:
(h) determining whether the subsurface model satisfies a threshold;
(i) if the subsurface model does not satisfy a design requirements, then (1) modifying the starting model and (2) repeating steps (c)-(g) generate the subsurface model; and
(j) if the subsurface model does satisfy the design requirements, then storing the subsurface model in the memory of a computer system.

17. The method of claim 1, wherein the seismic data are surface seismic data or check-shot seismic data.

18. A computer-implemented method for constructing a subsurface model of a subsurface volume from seismic data for a geophysical property, comprising:
(a) constructing a measurement vector from seismic data;
(b) constructing a kernel matrix from ray-path information;
(c) constructing a sensitivity optimization cost function based from the kernel matrix and on a sensitivity distribution;
(d) deriving data weighting vector by minimizing the sensitivity optimization cost function;
(e) constructing a sensitivity-controllable tomographic inversion cost function by applying the data weighting vector;
(f) obtaining a starting subsurface model; and
(g) generating a subsurface model of the geophysical property by solving the sensitivity-controllable tomographic inversion problem with the starting subsurface model, wherein the sensitivity-controllable tomographic inversion problem is based on the sensitivity-controllable tomographic inversion cost function.

19. The method of claim 18, wherein the step (c) comprises transposing the kernel matrix to build an adjoint sensitivity mapping matrix that is utilized to construct the sensitivity optimization cost function.

20. The method of claim 18, wherein the targeted sensitivity distribution is designed to have high sensitivity in the region of interest and to have low sensitivity in the remaining region.

21. The method of claim 18, wherein the step (d) comprises formulating a sensitivity optimization problem from the sensitivity optimization cost function and solving the sensitivity optimization problem, which is represented by the following equation:
min∥Bv−d∥,
where B is called the adjoint sensitivity mapping matrix defined by the following equation:
$$B = [ \begin{matrix}{A}^{T} & - s \\ \frac{r}{m} a & 0\end{matrix} ] ,$$
v is the extended weighting vector defined by the following equation:
$$v = [ \begin{matrix}w \\ c\end{matrix} ] ,$$
d is the weight normalization vector defined by the following equation:
$$d = [ \begin{matrix}0 \\ r\end{matrix} ] ,$$
and the scaling factor r is defined by the following equation:
$$r = \frac{1}{n} {\sum }_{i , j } {a}_{ij} .$$
where m is the number of measurements and n is the number of cells in the model domain, A^{T} denotes the transpose of the kernel matrix A and w is the m×1 data weighting vector to be solved for, whose elements are the diagonal entries of W, c is an unknown constant to be inverted, v is greater than and equal to 0, s is the targeted sensitivity distribution and a is a 1×m vector whose elements are 1.

22. The method of claim 18, wherein the step (d) comprises formulating a sensitivity optimization problem from the sensitivity optimization cost function and solving the sensitivity optimization problem, which is represented by the following equation:
min∥A^{T}w−s∥,
where A^{T} denotes the transpose of the kernel matrix A and w is the m×1 data weighting vector to be solved for, whose elements are the diagonal entries of W.

23. The method of claim 18, wherein the step (d) comprises using the conjugate gradient method or its variants to minimize the sensitivity optimization cost function.

24. The method of claim 18, wherein the step (d) comprises adding a box-constraint or a non-negative constraint in the deriving the data weighting vector from the sensitivity optimization cost function.

25. The method of claim 18, wherein the geophysical properties are one or more of (i) velocity; (ii) velocity anisotropy parameters; and (iii) seismic attenuation (Q).

26. A method for producing hydrocarbons from a subsurface region, comprising:
(a) obtaining seismic data from a survey of the subsurface volume;
(b) obtaining a subsurface model for the subsurface volume of a one or more geophysical properties, the subsurface model being generated by:
(i) constructing a measurement vector from seismic data;
(ii) constructing a kernel matrix from ray-path information;
(iii) constructing a sensitivity optimization cost function based on the kernel matrix;
(iv) deriving data weighting vector by minimizing the sensitivity optimization cost function;
(v) constructing a sensitivity-controllable tomographic inversion cost function by applying the data weighting vector;
(vi) obtaining a starting subsurface model; and
(vii) generating a subsurface model of the geophysical property by formulating and solving a sensitivity-controllable tomographic inversion problem with the starting subsurface model, wherein the sensitivity-controllable tomographic inversion problem is based on the sensitivity-controllable tomographic inversion cost function;
(c) imaging the seismic data using the subsurface model;
(d) drilling at least one well to the subsurface volume in a formation based on the seismic image; and
(e) producing hydrocarbons from the formation.

27. The method of claim 26, wherein the step (iii) comprising obtaining a targeted sensitivity distribution and using the targeted sensitivity distribution with the kernel matrix to construct the sensitivity optimization cost function.

28. The method of claim 26, wherein the step (iii) comprises transposing the kernel matrix to build an adjoint sensitivity mapping matrix that is utilized to construct the sensitivity optimization cost function.

29. The method of claim 27, wherein the targeted sensitivity distribution is designed to have high sensitivity in the region of interest and to have low sensitivity in the remaining region.

30. A computer system comprising:
a processor;
memory in communication with the processor; and
a set of instructions stored on the memory and accessible by the processor, wherein the set of instructions, when executed, are configured to: obtain a measurement vector and a kernel matrix;
construct a sensitivity optimization cost function based on the kernel matrix;
calculate a data weighting vector by minimizing the sensitivity optimization cost function;
construct a sensitivity-controllable tomographic inversion cost function by applying the data weighting vector;
obtain a starting subsurface model; and
produce a subsurface model of a geophysical property solving a sensitivity-controllable tomographic inversion problem with the starting subsurface model, wherein the sensitivity-controllable tomographic inversion problem is based on the sensitivity-controllable tomographic inversion cost function.

31. The computer system of claim 30, wherein the set of instructions is configured to obtain a targeted sensitivity distribution and to construct the sensitivity optimization cost function from the targeted sensitivity distribution with the kernel matrix.
